(19) United States
(12) Patent Application Publication
(10) Pub. No.: US 2005/0102471 A1
(43) Pub. Date: May 12, 2005

(54) Integrated portable storage apparatus

(76) Inventors: Yu-Wei Tsai, Hsin-Chu (TW); Yi-Feng Jang, Hsin-Chu (TW)

Correspondence Address: ANTHONY R BARKUME, 20 GATEWAY LANE, MANORVILLE, NY, 11949, US

(21) Appl. No.: 10/891,762

(22) Filed: Jul. 14, 2004

(30) Foreign Application Priority Data
Nov. 7, 2003 (TW) 092131172

(51) Int. Cl. G06F 12/00

(52) U.S. Cl. 711/115; 710/305

(57) ABSTRACT

A storage apparatus includes: a body; a serial interface connector, which is mounted to the body to connect with a host externally; and a single chip integrated circuit, which is positioned in the body, integrates a storage media and a serial interface, wherein the serial interface connects to the serial interface connector electrically, and the host is able to access the storage media through the serial interface.

### FIELD OF THE INVENTION

The present invention relates to an integrated portable storage apparatus. More particularly it relates to a device that integrates the storage media and serial interface together into a single chip integrated circuit. The device also includes a serial interface connector to be connected with a host externally for the data transmission.

### BACKGROUND OF THE INVENTION

In current fashions, portable storage apparatuses such as a USB flash drive, they all use a USB (Universal Serial Bus) controller IC with one or multiple NAND Flash (8M Bytes to 256M Bytes memory size) as the mainly architecture. However, the manufacturers of these USB flash drives usually be disturbed about the enhanced cost and producing interruption due to the lack of the NAND flash and the price raising. Further more, the high price of the NAND flash causes the street price of USB flash drive is expensive, which also limits the market of this storage apparatus.

In fact, for the application of the USB flash drive with 32M Bytes more memory size, users usually use it to store data temporally such as floppy disks. In other words, users buy a USB flash drive with 32M Bytes more memory size but usually just use 1M Bytes to 4M Bytes only, and waste the other storage space.

Thus, how to make users spend less money but can meet the demand for storing small sized data temporally, and also let the manufacturers who develop portable storage apparatuses have more options without any disturbance about the lack of NAND flash and the price raising, are the mainly object of the present invention.

### SUMMARY OF THE INVENTION

The objective of the present invention is to create an integrated portable storage apparatus without external NAND flash and to integrate a flash memory (not only NAND flash) with smaller memory size and a serial interface together into a single chip integrated circuit. Therefore, there is only one single chip integrated circuit and some passive components embedded in the integrated portable storage apparatus.

Another objective of this invention is to create a device that is about twice the size of a USB connector only and being convenient to take with.

According to the present invention, a storage apparatus includes:
A body;
A serial interface connector mounted to the body to connect with a host externally; and
A single chip integrated circuit located in the body for integrating a storage media and a serial interface, wherein the serial interface electrically connects to the serial interface connector and the host is able to access the storage media through the serial interface.

In accordance with one aspect of the present invention, the serial interface is a USB (Universal Serial Bus) interface and the connector is a USB interface connector.

In accordance with one aspect of the present invention, the serial interface is an IEEE 1394 interface and the connector is an IEEE 1394 interface connector.

In accordance with one aspect of the present invention, the host is a PC or a notebook.

In accordance with one aspect of the present invention, the memory size of storage media is 4M Bytes.

In accordance with one aspect of the present invention, the storage media is a non-volatilizable memory.

In accordance with one aspect of the present invention, the non-volatilizable memory is a flash memory.

In accordance with one aspect of the present invention, the single chip integrated circuit includes a processing unit to communicate with the signals between the serial interface and the storage media.

In accordance with one aspect of the present invention, the processing unit includes a CPU, a program memory, and a CPU interface; wherein the CPU fetches the program codes from the program memory to execute, and accesses the storage media through the CPU interface according to the accessing command from the serial interface.

In accordance with one aspect of the present invention, the program memory and the storage media is integrated together into a storage apparatus.

The present invention may best be understood through the following description with reference to the accompanying drawings, in which:

### BRIEF DESCRIPTION OF THE DRAWINGS

FIG. 1 shows a block diagram according to the present invention;

FIG. 2 shows the connection between the integrated portable storage apparatus and host; and

FIG. 3 shows the architecture of the single chip integrated circuit.

### DETAILED DESCRIPTION OF THE PREFERRED EMBODIMENT

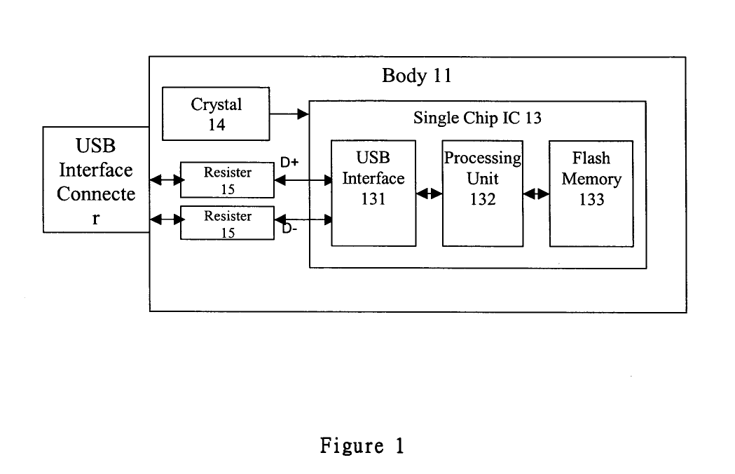

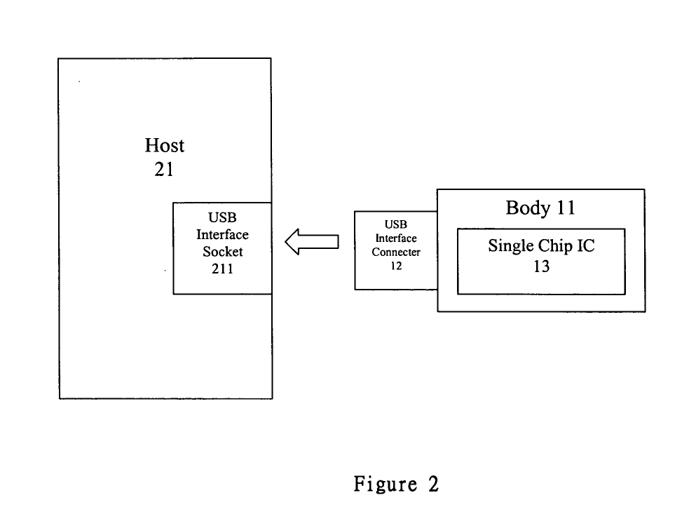

Please refer to FIG. 1, which is a preferred embodiment according to the present invention. In this diagram, the body 11 of the integrated portable storage apparatus in the present invention includes the USB interface connector 12, the single chip integrated circuit 13 (single chip IC), the crystal 14 and resister 15. In which the single chip IC 13 integrates the USB interface 131, the processing unit 132 and the flash memory 133 together. The system architecture as shown in FIG. 1, the USB interface connector 12 connects with the USB interface 131 by the resister 15 (and the signal line is D+ and D−), and the USB interface 131 is able to access the flash memory 133 by processing unit 132. Thus, as shown in FIG. 2, when the USB interface connector 12 plugged into the USB interface socket 211 of host 21 (just as a PC or a Notebook), host 21 will be able to access the flash memory 133 of the single chip IC 13 by the USB interface 121. For the crystal 14, it just provides the timing signals to the single chip IC 13.

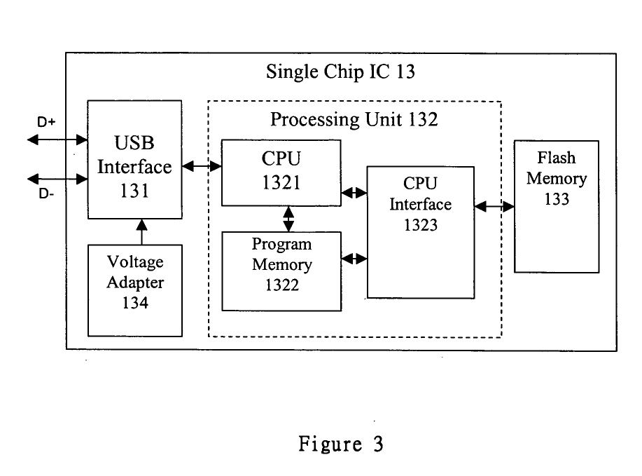

Please refer to FIG. 3, which is the block diagram of the single chip IC 13 for description in detail. As shown in the figure, the processing unit 132 is provided to communicate with the USB interface 131 and the flash memory 133, which consists of the CPU 1321, the program memory 1322, and the CPU interface 1323 (or a DMA, Direct Memory Accessing Unit). In which, the CPU 1321 fetches the program codes stored in the program memory 1322 to execute, and thereby the flash memory 133 can be accessed from the USB interface 131 through the CPU interface 1323. The voltage adapter 134 is provided to adapt the voltage and to supply a stable power source to the USB interface 131.

Furthermore, the flash memory 133 that is embedded in single chip IC 13 and provided as the mainly storage media of the storage apparatus can stay alone as shown in FIG. 3, or could be integrated with program memory 1322 as a common flash memory, thereby the processing unit 132 will be able to control the common flash memory directly when the host requests an accessing command of standard storage media.

The preferred embodiment of the present invention is very similar with the prior USB flash memory functionally, both of them providing users a convenient and portable storage apparatus. But the present invention features the serial interface (just as USB or IEEE 1394) and storage media (just likes a flash memory) integrating together into a single chip integrated circuit. In order to integrate them into a single chip IC, the storage media must has the same producing process as the single chip IC, and the memory size of the storage media can not be too large (based on the current technology, the memory size is about 4M Bytes). This just commits the requirement of the present invention. If the memory size of the storage media is less or equal to 4M Bytes, then the flash memory will not be limited for using NAND Flash but can be replaced by others. So, the material supply will not be limited and the price movement will also be controlled. Of course, if the technology of IC producing process is improved in the future, the present invention can also integrate a larger memory sized storage media (just as larger than 4M Bytes flash) into the single chip integrated circuit, to provide users a bigger memory sized storage apparatus. Furthermore, due to all the functions of the integrated portable storage apparatus in the present invention are all integrated in the single chip IC, so the device can be produced as a very small size, which is about twice the size of a USB connector, and whereby make users much more convenient for portable usage. To sum up, the integrated portable storage apparatus of the present invention has more advantages than the prior art, and is really able to satisfy more requirements of most users.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims that are to be accorded with the broadest interpretation so as to encompass all such modifications and similar structures.

1. An integrated portable storage apparatus comprising:
a body;
a serial interface connector mounted to said body to connect with a host externally; and
a single chip integrated circuit in said body for integrating a storage media and a serial interface at least, said serial interface connecting to said serial interface connector electrically, and said host being able to access said storage media through said serial interface.

2. The integrated portable storage apparatus according to claim 1 wherein said serial interface is a USB (Universal Serial Bus) interface and said connector is a USB interface connector.

3. The integrated portable storage apparatus according to claim 1 wherein said serial interface is an IEEE 1394 interface and said connector is an IEEE 1394 interface connector.

4. The integrated portable storage apparatus according to claim 1 wherein said host is a PC or notebook.

5. The integrated portable storage apparatus according to claim 1 wherein the memory size of said storage media is 4M Bytes.

6. The integrated portable storage apparatus according to claim 1 wherein said storage media is a non-volatilizable memory.

7. The integrated portable storage apparatus according to claim 6 wherein said non-volatilizable memory is a flash memory.

8. The integrated portable storage apparatus according to claim 1 wherein said single chip integrated circuit includes a processing unit to communicate with the signals between said serial interface and said storage media.

9. The integrated portable storage apparatus according to claim 8 wherein said processing unit includes a CPU, a program memory, and a CPU interface, said CPU fetches the program codes from said program memory to execute, and accesses said storage media through said CPU interface according to the accessing command from said serial interface.

10. The integrated portable storage apparatus according to claim 9 wherein said program memory and said storage media can be integrated together into storage apparatus.
